(19) United States
(12) Patent Application Publication
(10) Pub. No.: US 2012/0328273 A1
(43) Pub. Date: Dec. 27, 2012

(54) HEAT TREATMENT APPARATUS AND HEAT TREATMENT METHOD

(76) Inventors: Hisashi KAWANO, Koshi City (JP); Ryouichi Uemura, Koshi City (JP); Kousuke Yoshihara, Koshi City (JP); Shigeru Kasai, Nirasaki City (JP); Keiji Tanouchi, Nirasaki City (JP); Makoto Muramatsu, Nirasaki City (JP); Mitsuaki Iwashita, Nirasaki City (JP); Masatake Yoneda, Nirasaki City (JP); Kazuhiro Ooya, Nirasaki City (JP)

(21) Appl. No.: 13/524,023

(22) Filed: Jun. 15, 2012

(30) Foreign Application Priority Data
Jun. 22, 2011 (JP) 2011-138867

(51) Int. Cl. H05B 6/00

(52) U.S. Cl. 392/418

(57) ABSTRACT

Disclosed is a thermal processing apparatus and method that can acquire a high throughput and reduce the occupation area of the thermal processing apparatus. A wafer is heated by an LED module that irradiates infrared light corresponding to the absorption wavelength of the wafer, and therefore, the wafer can be rapidly heated. Since an LED is used as a heat source and a temperature rise of LED is small, a cooling process after the heating process can be performed in the same process area as the heating process area. As a result, an installation area of the thermal processing apparatus can be reduced. Since the time for moving between a heating process area and a cooling process area can be saved, a time required for a series of processes including the heating process and the subsequent cooling process can be shortened, thereby improving a throughput.

### CROSS-REFERENCE TO RELATED APPLICATIONS

This application is based on and claims priority from Japanese Patent Application No. 2011-138867, filed on Jun. 22, 2011, with the Japanese Patent Office, the disclosure of which is incorporated herein in its entirety by reference.

### TECHNICAL FIELD

The present disclosure relates to a heat treatment (e.g., a thermal processing) technique for a substrate.

### BACKGROUND

A heating process of a substrate is performed during a photolithography process or an insulating film forming process by applying a chemical liquid in fabricating a semiconductor. A heater or a halogen lamp including a resistance heating element is used as a heat source of the heating process, but the heat source is slow in responsiveness of temperature control while starting and stopping. Therefore, it takes a relatively long time, for example, tens of seconds, until the temperature of the heat source is stable by reaching a predetermined temperature after starting. As a result, since the heat source has a high temperature just after a heating process is completed, cooling efficiency deteriorates when cooling the substrate in a heating area with the heat source. Accordingly, a thermal processing apparatus adopts a configuration in which a heating area and a cooling area are separated from each other and for example, a cooling plate that moves between the cooling area adjacent to the heating area and a position above the heating area is installed, and receives the heat-processed substrate, and moves the substrate up to the cooling area. In this configuration, an installation area of the thermal processing apparatus increases, and a time is required for moving the substrate before the heating process from the cooling area to the heating area and for moving the substrate after the heating process from the heating area to the cooling area, which is one of the reasons why improvement of a throughput is suppressed.

In a photolithography process, in order to promote an acid-catalyst reaction by acid generated by an exposure process, a heating process called as a post exposure bake (PEB) is performed between an exposure process and a development process. However, slow starting or unstable temperature of the heat source at the time of starting the heat source makes it difficult to control the acid-catalyst reaction in the PEB to cause pattern resolution formed by a development process to deteriorate. In recent years, since a pattern size of the semiconductor has been miniaturized, it is important that a start time at the time of starting the heat source be short in order to suppress the deterioration of the resolution.

Japanese Patent Application Laid-Open No. 2010-153734 discloses an annealing apparatus of heating a substrate to be treated by irradiating the substrate with light by using light emitting diodes (LEDs), but the context of the invention thereof relates to cooling of the LEDs in order to prevent a light emitting amount from being reduced by heat emission of the LEDs and is different from the present disclosure.

### SUMMARY

An exemplary embodiment of the present disclosure provides a thermal processing apparatus heating a substrate, comprising: a placement table configured to place the substrate thereon; a cooling unit configured to cool the substrate through the placement table; a heat source installed opposite to the placement table using a light emitting diode and configured to heat the substrate by irradiating radiation light having an absorption wavelength range of a material of the substrate; and a control unit configured to output a control signal so as to cool the substrate using the cooling unit in a state where the light emitting diode is turned OFF and the substrate is placed on the placement table after heating the substrate using the light emitting diode.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a longitudinal side view illustrating a thermal processing apparatus according to a first exemplary embodiment of the present disclosure.

FIG. 2 is an enlarged longitudinal side view illustrating a heat source in the thermal processing apparatus according to the first exemplary embodiment.

FIG. 3 is a plan view illustrating the heat source and a cooling unit in the thermal processing apparatus according to the first exemplary embodiment.

FIG. 4 is a longitudinal side view schematically illustrating an operation in the first exemplary embodiment.

FIG. 5 is a longitudinal side view illustrating a thermal processing apparatus according to a second exemplary embodiment of the present disclosure.

FIG. 6 is a plan view illustrating a heat source and a cooling unit in the thermal processing apparatus according to the second exemplary embodiment.

FIG. 7 is a longitudinal side view schematically illustrating an operation in the second exemplary embodiment.

FIG. 8 is a longitudinal side view schematically illustrating an operation in a third exemplary embodiment of the present disclosure.

FIG. 9 is a longitudinal side view illustrating a thermal processing apparatus according to a fourth exemplary embodiment of the present disclosure.

FIG. 10 is a perspective longitudinal cross-sectional view illustrating the thermal processing apparatus according to the fourth exemplary embodiment.

FIG. 11 is a longitudinal side view schematically illustrating an operation in the fourth exemplary embodiment.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

The present disclosure has been made in an effort to provide a thermal processing technique that can acquire a high throughput and has a small exclusive occupation area of a thermal processing apparatus, in a thermal processing technique of heating a substrate to be processed and thereafter, cooling the substrate.

An exemplary embodiment of the present disclosure provides a thermal processing apparatus heating a substrate, comprising: a placement table configured to place the substrate thereon; a cooling unit configured to cool the substrate through the placement table; a heat source installed opposite to the placement table using a light emitting diode and configured to heat the substrate by irradiating radiation light having an absorption wavelength range of a material of the substrate; and a control unit configured to output a control signal so as to cool the substrate using the cooling unit in a state where the light emitting diode is turned OFF and the substrate is placed on the placement table after heating the substrate using the light emitting diode.

The above described thermal processing apparatus further comprises an elevation mechanism configured to elevate the substrate between a heating position spaced above the placement table and a placement position on the placement table. The control unit outputs a control signal so as to heat the substrate at the heating position in a state where the substrate is supported by the elevation mechanism and thereafter, to place the substrate at the placement position using elevation mechanism in order to cool the substrate.

In the above described thermal processing apparatus, the cooling unit includes a circulation passage for circulating a cooling fluid.

In the above described thermal processing apparatus, the cooling unit stops the circulation of the cooling fluid at the time of heating the substrate.

Another exemplary embodiment of the present disclosure provides a thermal processing method for a substrate, comprising: supporting the substrate in a horizontal direction; heating the substrate with a heat source provided to oppose the substrate with a space using a light emitting diode and configured to irradiate radiation light having an absorption wavelength range of a material of the substrate; and cooling the substrate through a placement table using a cooling unit in a state where the light emitting diode is turned OFF and the substrate is placed on the placement table opposite to the heat source.

In the above described thermal processing method, at the supporting step, the substrate is supported at a heating position spaced above the placement table by an elevation mechanism, and at the cooling step, the substrate is placed on the placement table by the elevation mechanism.

According to the exemplary embodiments of the present disclosure, since a light emitting diode (LED) is used as a heat source of a heating process for a substrate, the substrate can be rapidly heated, and since an increase in temperature of the heat source itself is small, a heating process and a subsequent a cooling process can be performed in the same area. As a result, a throughput can be improved and an installation area of a thermal processing apparatus can be prevented from being increased.

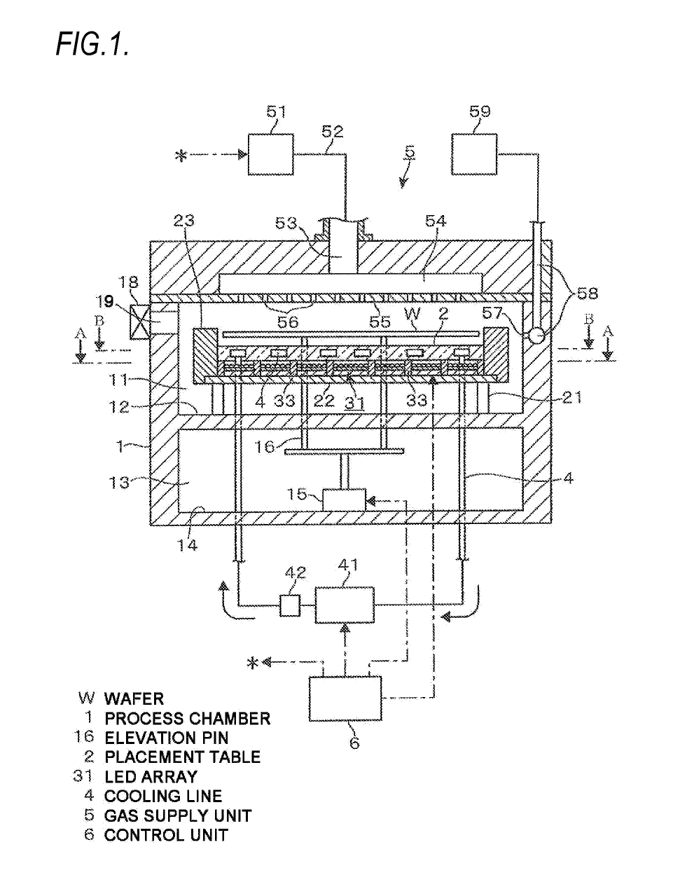

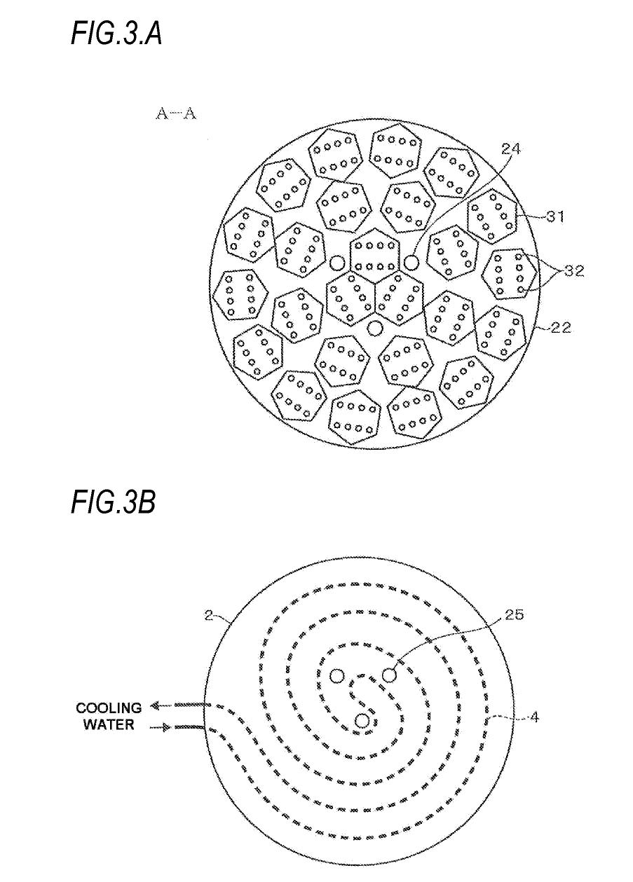

According to a first exemplary embodiment of the present disclosure, a thermal processing apparatus that thermal-processes a silicon wafer W (hereinafter, referred to as a ‘wafer’) as a substrate will be described. A process chamber 1 of the present thermal processing apparatus has a two-layered structure of upper and lower floors, and an upper floor 11 thereof is used as a thermal processing area, as illustrated in FIG. 1. A high thermal conductive base 22 is installed on a bottom surface 12 of upper floor 11 through a support member 21. A plurality of LED arrays 31 are paved and installed on base 22 and for example, are fixed to base 22 by stainless-made fixation screws 32, as illustrated in FIG. 3A. LED array 31 is surrounded by a reflection plate 33 acquired by, for example, plating a copper (Cu) plate with gold throughout an entire circumference of the LED array 31, and radiation light may be effectively extracted by reflecting light in a direction different from an irradiation direction (an upward direction in FIG. 1). An LED module 3 including LED arrays 31 and reflection plates 33 corresponds to a heat source. In FIG. 3A, reflection plate 33 is not illustrated.

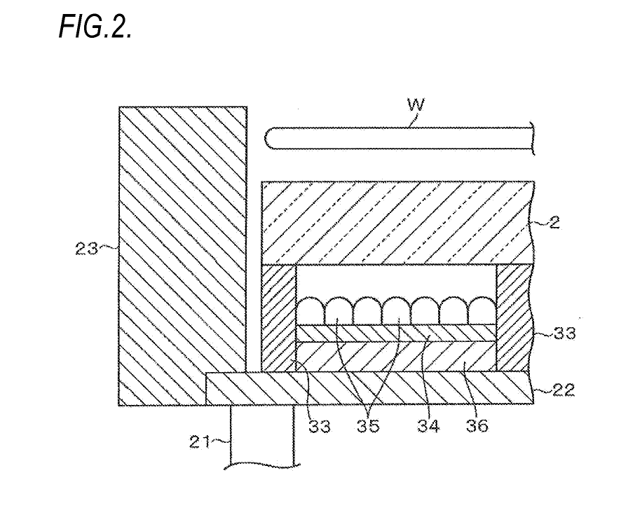

Herein, LED array 31 will be described in detail with reference to the enlarged view of FIG. 2. LED array 31 include a supporter 34 made of a high thermal conductive material having an insulating property such as, for example, a nitride aluminum containing resin, a plurality of LEDs 35 supported on the surface of supporter 34 through an electrode (not illustrated), and a heat diffusion member 36 made of, for example, Cu which is a high thermal conductive material bonded to a back surface of supporter 34. An electrode having high conductivity, which is acquired by for example, plating Cu with gold, is patterned on supporter 34, and LED 35 is bonded to the electrode by a conductive and high thermal conductive bonding material (not illustrated) made of, for example, silver paste. Supporter 34 and heat diffusion member 36 are bonded by the high thermal conductive bonding material (not illustrated) such as solder or silver paste.

By this configuration, heat generated from LEDs 35 may be effectively discharged through a path having good thermal conductivity, which includes supporter 34, heat diffusion member 36, and base 22. Although not illustrated because the drawing becomes complicated, LEDs 35 described in the present specification include a wire electrically connecting an LED element of LED 35 and an electrode of another LED 35 adjacent to LED 35, an infrared light reflection material installed at a part without a Cu pattern electrode on the surface of supporter 34, and a lens layer which is installed to cover the LED element, serves to extract for example, infrared light ejected from the LED element, and is made of, for example, a transparent resin.

A placement table 2 for placing wafer W thereon is installed above LED arrays 31 while being supported by reflection plates 33. In other words, LED module 3 is installed below placement table 2 while facing the placement table 2. Placement table 2 is made of, for example, quartz capable of transmitting the light irradiated from LED array 31. A cooling line 4 serving as a circulation passage for circulating refrigerant, for example, cooling water is installed in placement table 2 as illustrated in FIG. 3B, and placement table 2 also serves as a cooling member for cooling wafer W after the heating process. Cooling line 4 is connected to a chiller 41 and a circulation pump 42 installed outside process chamber 1, and the refrigerant that is circulated within the cooling line is adjusted to have a set temperature by chiller 41 and sent into placement table 2 by circulation pump 41.

A ring support 23 is installed to be fixed to base 22 so as to surround base 22, LED module 3, and placement table 2. Ring support 23 protrudes upward on the top of placement table 2, a space area in which wafer W can be inserted is formed in an area surrounded by ring support 23 above placement table 2, and wafer W is heated in the space area. The surface of ring support 23 is polished, which is made of, for example, aluminum (Al), and similarly as reflection plate 33, the surface of ring support 23 serves to improve irradiation efficiency by reflecting the light irradiated from LED array 31.

An elevation unit 15 is installed in a lower floor 13 of process chamber 1 to be fixed on a bottom surface 14 thereof, and elevation pins 16 are installed to be elevated by elevation unit 15. Elevation pins 16 are installed to pass through bottom surface 12 (a ceiling of lower floor 13), and through-holes 24, 25 through which elevation pins 16 can pass are installed in base 22 and placement table 2, respectively, as illustrated in FIG. 3. Wafer W is transferred between a transport arm 17 that is installed outside process chamber 1 to carry in/out wafer W to/from process chamber 1, and placement table 2 through elevation pins 16. Elevation pins 16 may keep wafer W to be spaced apart from placement table 2 during the heating of wafer W. Elevation unit 15 and elevation pins 16 correspond to an elevation mechanism.

A gas supply unit 5 is installed on a ceiling portion of process chamber 1. Gas supply unit 5 includes a gas supply system 51 including a gas supply source and a gas supply controller such as a valve, which are installed outside the present thermal processing apparatus, a pipe 52, a gas inflow port 53 installed on the upper side of process chamber 1, a buffer chamber 54, and a ceiling panel 55 serving as a gas supply unit to the thermal processing area. The concentration and flow rate of gas are adjusted first to be supplied to buffer chamber 54 from gas supply system 51 through pipe 52 and gas inflow port 53. Buffer chamber 54 is a space surrounded by the ceiling portion of process chamber 1 and ceiling panel 55 installed below the ceiling portion. Ceiling panel 55 is made of, for example, Al, and installed to face placement table 2. A plurality of small gas supply holes 56 are punched on ceiling panel 55, such that atmospheric pressure in buffer chamber 54 is kept to a predetermined level or higher by adjusting the amount of gas supplied to buffer chamber 54 to evenly supply gas throughout the thermal processing area.

A plurality of gas discharge holes 57 are installed throughout an entire circumference of a place corresponding to the height of the thermal processing area on an inner side wall of process chamber 1. Gas discharge holes 57 are connected to a gas discharge system 59 including, for example, a gas processing mechanism that processes gas to be safely discharged to the outside or an exhaust pump through a gas discharge pipe 58 installed inside a side wall of process chamber 1. Gas in process chamber 1 is sent to the gas discharge system through gas discharge holes 57 and gas discharge pipe 58. The gas is processed to be in a safe state in the gas discharge system and thereafter, discharged.

A carry-in port 19 is installed on the side wall of process chamber 1, and wafer W is carried in/out to/from process chamber 1 through carry-in port 19. Carry-in port 19 may be opened/closed by a shutter 18.

A control unit 6 is installed in the present thermal processing apparatus. Control unit 6 controls various operations including an elevating operation of elevation pins 16 by the elevation mechanism, the temperature control of the refrigerant or an ON/OFF operation of circulation pump 42 by chiller 41, the intensity control or ON/OFF operation of irradiation by LED module 3, and a gas supplying operation by gas supply unit 5 based on, for example, an operating program input into control unit 6 in advance.

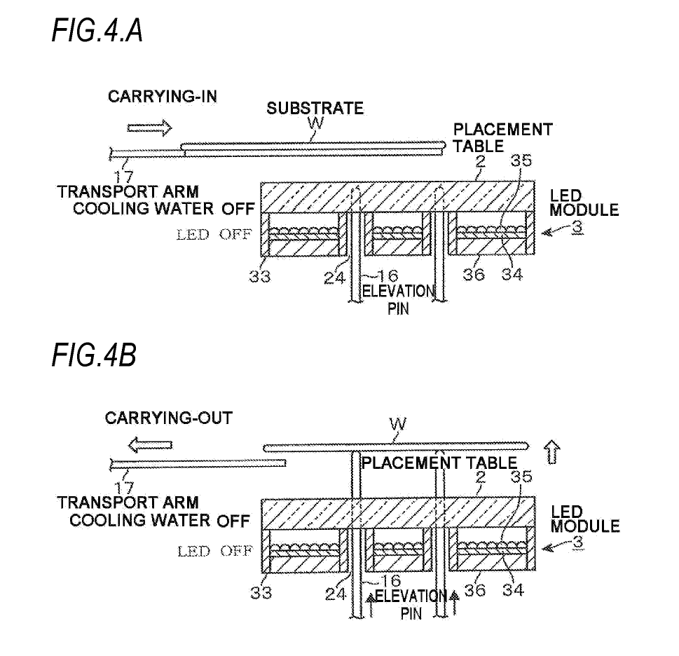

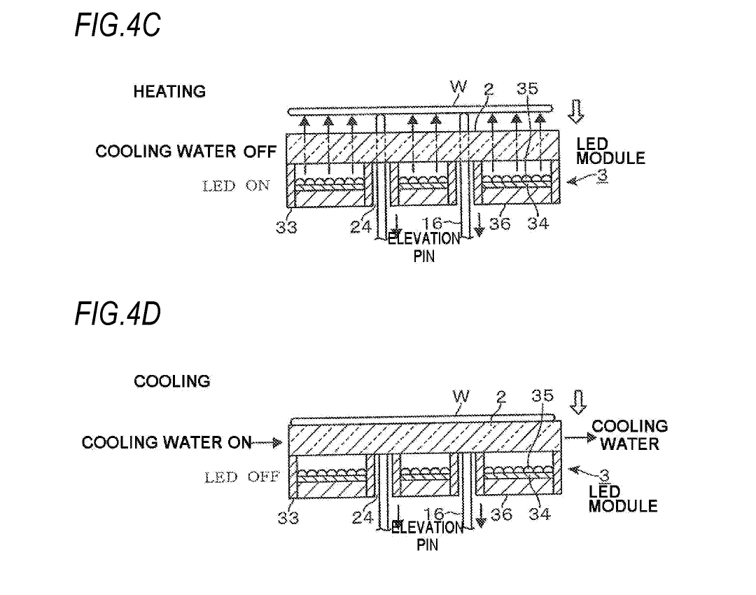

Subsequently, an operation in the first exemplary embodiment will be described with reference to FIG. 4. First, wafer W is carried into process chamber 1 by transport arm 17 (FIG. 4A). At this time, LED module 3 is turned OFF and the circulation of the cooling water (cooling of the placement table) stops (circulation pump 42 is turned OFF). When wafer W held by transport arm 17 reaches a place above placement table 2, elevation pins 16 push up wafer W from below by lifting elevation pins 16 using elevation unit 15 to receive wafer W from transport arm 17. Transport arm 17 that has transferred wafer W is then withdrawn from process chamber 1 (FIG. 4B).

Elevation pins 16 are descended to move wafer W to a height (a heating height position) at which heating process is performed. The heating height position described herein is a height position (a height position lower than the top of ring support 23) at which wafer W is surrounded by ring support 23 and represents a position spaced upward so as not to be influenced by a cooling operation from placement table 2. Specifically, the height from the top of placement table 2 to the bottom of wafer W is, for example, 6 mm. When wafer W is held at the heating height position, infrared light as radiation light in an absorption wavelength range of wafer W is irradiated toward wafer W by LED module 3 to heat wafer W at a predetermined heating process temperature, for example, 90° C. to 150° C. (see, e.g., FIG. 4C).

When a predetermined heating time, for example, 30 seconds to 150 seconds has elapsed, LED irradiation stops and the circulation of the cooling water starts to cool placement table 2. Elevation pins 16 are descended to transfer and place wafer W onto placement table 2. Therefore, wafer W heated by the heating process is cooled by cooling line 4 where the cooling water is circulated, as a cooling unit through placement table 2 (see, e.g., FIG. 4D).

When a predetermined cooling time has elapsed, the circulation of the cooling water stops and elevation pins 16 are lifted to push up wafer W from placement table 2, and as a result, elevation pins 16 are lifted directly up to a transfer height position operated with transport arm 17. Wafer W is transferred to transport arm 17 by putting transport arm 17 to a transfer position of wafer W in process chamber 1 and thereafter, descending elevation pins 16. Transport arm 17 receiving wafer W moves backward while holding wafer W to carry out wafer W from process chamber 1.

According to the exemplary embodiment described as above, since wafer W is heated by irradiating infrared light which is absorption wavelength light of silicon which is a material of wafer W from LED module 3, wafer W may be rapidly heated after turning ON LED module 3. Since a rise amount in temperature of LED 35 as the heat source is small, wafer W is cooled after the heating process in the same process area as the heating treatment area. As a result, an installation area of the thermal processing apparatus can be prevented from being increased. Since a movement time between the heat process area and the cooling process area can be saved, a time required for a series of processes of the heating process and the subsequent cooling process can be shortened, thereby improving the throughput.

When the substrate is heated using a heating plate, the temperature of the heating plate cannot be raised or dropped rapidly due to a heat capacity thereof. In contrast, when LED module 3 is used, a heat radiation amount is instantaneously followed according to a change of an output. As a result, a change in the heating process temperature according to a change of a lot of wafer W may be rapidly attained. Therefore, the throughput may be improved.

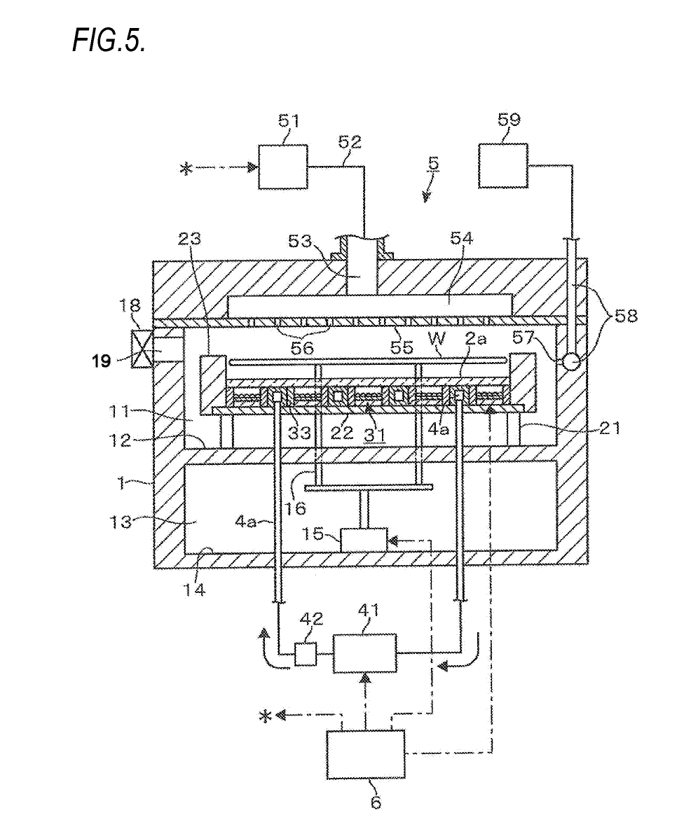

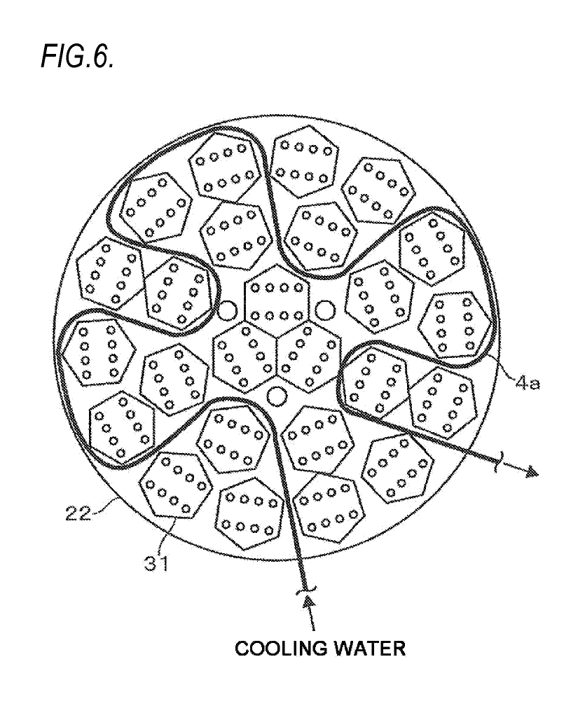

Next, a second exemplary embodiment of the present disclosure will be described with reference to FIGS. 5 to 7. Constituent members having the same structures and functions as the first exemplary embodiment will be designated by the same reference numerals as the first exemplary embodiment and the descriptions thereof will be omitted. In the present exemplary embodiment, an installation position of a cooling line 4a is different from that of the first exemplary embodiment. Cooling line 4a of the present exemplary embodiment is configured to exert the cooling operation evenly to all LED arrays 31 by being surrounded on base 22 to be adjacent to at least some of each of LED arrays 31 as illustrated in FIGS. 5 and 6 instead of installing cooling line 4 in a placement table 2a as in the first exemplary embodiment. Cooling line 4a is in contact with placement table 2a thereabove and may cool both placement table 2a and LED arrays 31.

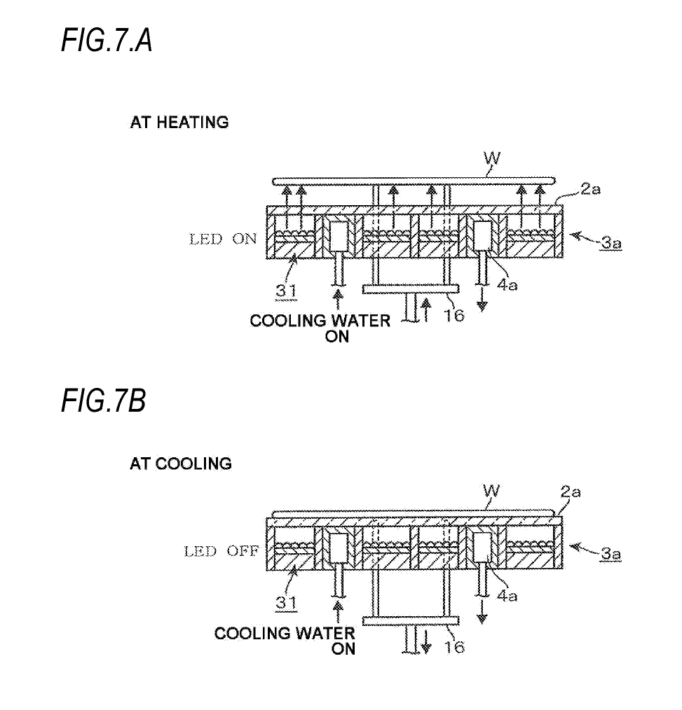

An operation of the present exemplary embodiment will be described. Since carrying in/out wafer W to/from process chamber 1 is the same as in the first exemplary embodiment, the descriptions thereof will be omitted. First, at the time of heating wafer W, the height position of wafer W is maintained at a position spaced from placement table 2a by elevation pins 16 as illustrated in FIG. 7A similarly as in the first exemplary embodiment. At the time of performing the cooling process, as illustrated in FIG. 7B, irradiation by an LED module 3a stops and wafer W is placed on placement table 2a by dropping elevation pins 16. The present exemplary embodiment is different from the first exemplary embodiment in that the cooling water is circulated in cooling line 4a even during the heating process as well as the cooling process. Since the rise in temperature of LED 35 itself may be suppressed by circulating the cooling water even in heating process, the irradiation by LED module 3a may be stably and efficiently performed. Since cooling line 4a is not installed within placement table 2a, the thickness of placement table 2a can be reduced, thereby allowing the apparatus to be formed compactly. The present exemplary embodiment is advantageous in the above points as compared with the first exemplary embodiment.

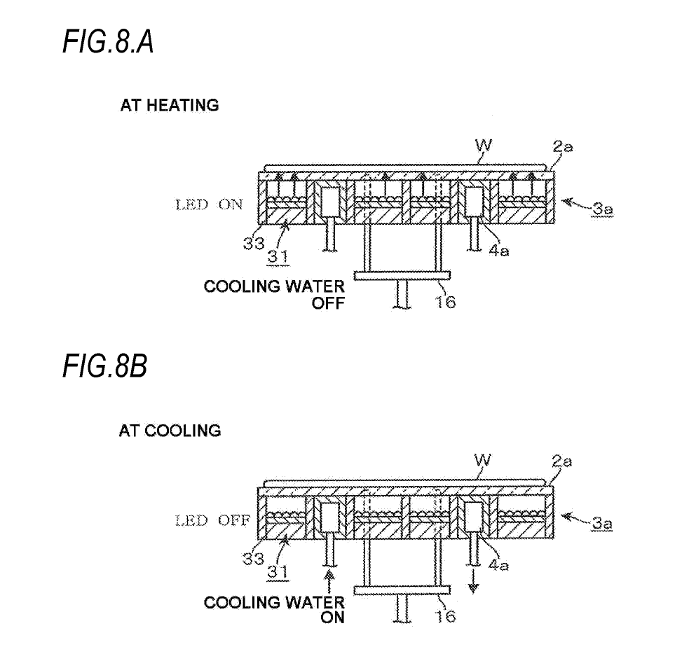

A third exemplary embodiment of the present disclosure will be described with reference to FIG. 8. Since the structure of the apparatus in the present exemplary embodiment is similar to the second exemplary embodiment, the descriptions thereof will be omitted. Since carrying in/out wafer W to/from process chamber 1 is similar to the second exemplary embodiment, the descriptions thereof will be omitted. The present exemplary embodiment is different from the second exemplary embodiment in that the heating process is performed while wafer W is being placed on placement table 2a as illustrated in FIG. 8A and the cooling water is not circulated in cooling line 4a. In regard to the cooling process, the present exemplary embodiment is similar to the second exemplary embodiment as illustrated in FIG. 8B. According to the present exemplary embodiment, since cooling line 4a is not installed within placement table 2a, the thickness of placement table 2a can be reduced, thereby allowing the apparatus to be formed compactly, similarly as the second exemplary embodiment, in addition to the effect of the first exemplary embodiment.

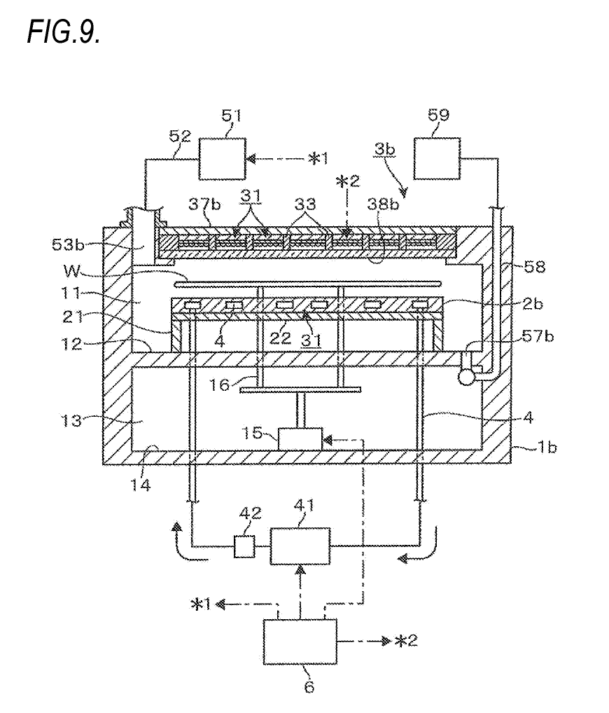

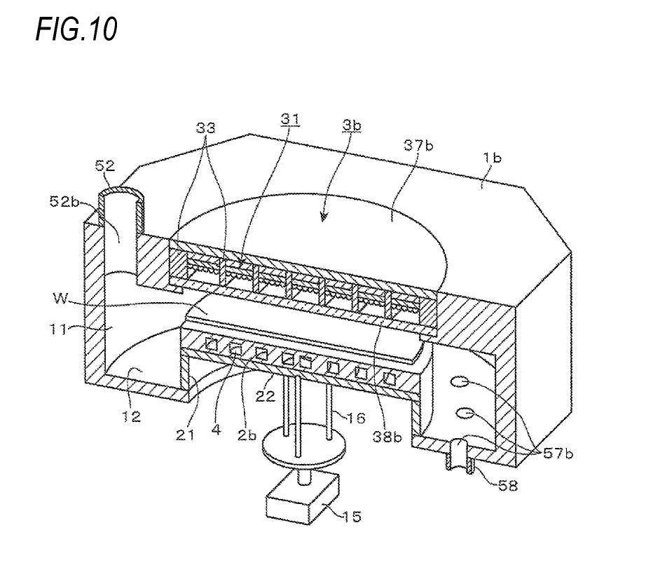

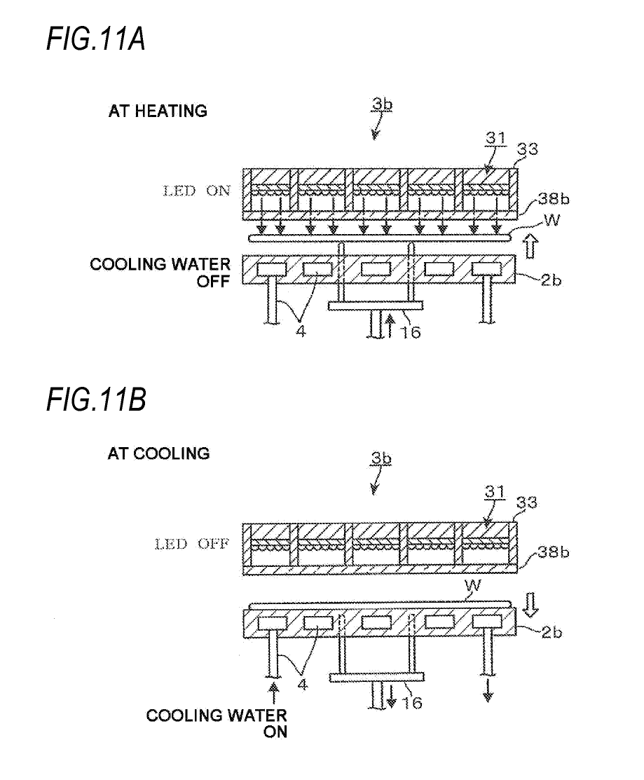

Subsequently, a fourth exemplary embodiment of the present disclosure will be described with reference to FIGS. 9 to 11. The present exemplary embodiment is different from the first exemplary embodiment in that an LED module 3b is installed on a ceiling portion of a process chamber 1b to face the top of placement table 2b. As a result, in regard to a mechanism that supplies/discharges purge gas into/from process chamber 1b, the present exemplary embodiment is different from the first exemplary embodiment. Constituent members having the same structures and functions as the first exemplary embodiment will be designated by the same reference numerals as the first exemplary embodiment. First, the present exemplary embodiment is the same as the first exemplary embodiment in that cooling line is installed within placement table 2b, but in the present exemplary embodiment, since infrared light is irradiated from the above by LED module 3b, a separate material through which infrared light penetrates need not be used for placement table 2b. As a result, a high thermal conductive material such as Cu may be used for placement table 2b.

LED module 3b is constituted by a support plate 37b, LED arrays 31, reflection plates 33, and a transmissive cover 38b. Plural LED arrays 31 are fixed onto the bottom of high thermal conductive support plate 37b by the fixation screws to irradiate infrared light downward and a periphery thereof is surrounded by reflection plates 33. Transmissive cover 38b made of a material which can transmit infrared light, for example, quartz, is installed below LED arrays 31 and is fixed to reflection plates 33.

A gas inflow port 53b of the present exemplary embodiment is installed at an end of the ceiling portion of process chamber 1b in order to avoid LED module 3b. A plurality of gas discharge holes 57b are installed at bottom surface 12 of upper floor 11 which is opposite side to gas inflow port 53b and the flow of gas is formed in one direction in the thermal processing area.

In the present exemplary embodiment, at the time of performing the heating process, wafer W is spaced apart from placement table 2b to be maintained at the height position by elevation pins 16 that performs the heating process, and infrared light is irradiated to wafer W from above by LED module 3b. In this case, the circulation of the cooling water through cooling line 4 stops. In the subsequent cooling process, irradiation of infrared light stops and the cooling water is circulated through cooling line 4. Elevation pins 16 are descended to transfer and place wafer W onto placement table 2b.

In the present exemplary embodiment, since infrared light need not penetrate placement table 2b, a material selection width of placement table 2b is increased, and as a result, a material having a higher cooling effect may be advantageously used.

The cooling unit is not limited to the circulation of the cooling water and may be for example, a Peltier element. In this case, the control of turning-ON/OFF of the circulation of the cooling water may be replaced with turning-ON/OFF of the Peltier element.

Finally, a case in which the present disclosure is applied to a post exposure bake (PEB) which is the heating process after an exposure process will be described. When a chemical amplification type resist including an acid generator and a polymer having an alkali insoluble protection group is used, acid is generated at a portion of a resist film which is exposed as light reaches the acid generator. The generated acid reacts with the alkali insoluble protection group of the polymer, which converts the alkali insoluble protection group into an alkali soluble group and causes a so-called acid-catalyst reaction in which the reaction is repeated next to next. By performing the heating process in this state, the acid-catalyst reaction is promoted, such that the polymer is alkali-soluble in the portion of the resist film which is exposed. The PEB-processed substrate is developed by a strong alkaline developer, such that the resist film of the exposed portion is dissolved by the developer to be removed and a resist pattern is formed on the substrate. Accordingly, in the PEB process, it is important to control a timing of stopping the heating of the substrate precisely.

According to the present exemplary embodiment of the present disclosure, the radiation heating by irradiation of infrared light from LED module 3 can be stopped, and the acid-catalyst reaction can be stopped. As a result, variation of a line width of the resist pattern can be suppressed.

The present disclosure can be applied to various thermal processing in a photolithography process, such as a pre-bake after application of resist and a post-bake after the development process even in addition to the post exposure bake (PEB) process after the exposure process. The present disclosure can be applied even to the thermal processing or an annealing process in for example, an application process of an insulating film.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A thermal processing apparatus heating a substrate, comprising:
a placement table configured to place the substrate thereon;
a cooling unit configured to cool the substrate through the placement table;
a heat source installed opposite to the placement table using a light emitting diode and configured to heat the substrate by irradiating radiation light having an absorption wavelength range of a material of the substrate; and
a control unit configured to output a control signal so as to cool the substrate using the cooling unit in a state where the light emitting diode is turned OFF and the substrate is placed on the placement table after heating the substrate using the light emitting diode.

2. The thermal processing apparatus of claim 1, further comprising:
an elevation mechanism configured to elevate the substrate between a heating position spaced above the placement table and a placement position on the placement table,
wherein the control unit outputs a control signal so as to heat the substrate at the heating position in a state where the substrate is supported by the elevation mechanism and thereafter, to place the substrate at the placement position using the elevation mechanism in order to cool the substrate.

3. The thermal processing apparatus of claim 2, wherein the cooling unit includes a circulation passage for circulating a cooling fluid.

4. The thermal processing apparatus of claim 3, wherein the cooling unit stops the circulation of the cooling fluid at the time of heating the substrate.

5. The thermal processing apparatus of claim 1, wherein the cooling unit includes a circulation passage for circulating a cooling fluid.

6. A thermal processing method for a substrate, comprising:
supporting the substrate in a horizontal direction;
heating the substrate with a heat source provided to oppose the substrate with a space using a light emitting diode and configured to irradiate radiation light having an absorption wavelength range of a material of the substrate; and
cooling the substrate through a placement table using a cooling unit in a state where the light emitting diode is turned OFF and the substrate is placed on the placement table opposite to the heat source.

7. The thermal processing method of claim 6,
wherein at the supporting step, the substrate is supported at a heating position spaced above the placement table by an elevation mechanism, and
at the cooling step, the substrate is placed on the placement table by the elevation mechanism.

8. The thermal processing method of claim 6, wherein the cooling unit stops the circulation of the cooling fluid at the time of heating the substrate.
